(19) United States
(12) Patent Application Publication
(10) Pub. No.: US 2009/0029041 A1
(43) Pub. Date: Jan. 29, 2009

(54) Method of cleaning a substrate for a magnetic recording medium and a method of manufacturing a magnetic recording medium

(75) Inventors: Jun Natsume, Matsumoto City (JP); Shoji Sakaguchi, Matsumoto City (JP); Takashi Shimada, Matsumoto City (JP)

Correspondence Address: RABIN & Berdo, PC, 1101 14TH STREET, NW, SUITE 500, WASHINGTON, DC, 20005, US

(73) Assignee: Fuji Electric Device Technology Co., Ltd., Tokyo (JP)

(21) Appl. No.: 12/216,807

(22) Filed: Jul. 10, 2008

(30) Foreign Application Priority Data
Jul. 12, 2007 (JP) PA 2007-183267

(51) Int. Cl. B05D 3/10; C11D 7/02

(52) U.S. Cl. 427/129; 510/167

(57) ABSTRACT

The invention provides a method of cleaning a magnetic recording medium substrate that removes residual substances and suppresses oxidation of the substrate surface. The method of cleaning the magnetic recording medium substrate uses nano-bubble water. Also disclosed is a method of manufacturing a magnetic recording medium that includes the method of cleaning the magnetic recording medium substrate and steps of sequentially forming at least a magnetic layer, a protective layer, and a liquid lubricant layer on the cleaned substrate.

### CROSS-REFERENCE TO RELATED APPLICATION

This Application is based on, and claims priority to, Japanese Patent Application No. 2007-183267 filed on Jul. 12, 2007, the contents of which are incorporated herein by reference.

### BACKGROUND OF THE INVENTION

1. Field of the Invention

The present invention relates to a method of cleaning a substrate for a magnetic recording medium and a method of manufacturing a magnetic recording medium including the cleaning method.

2. Description of the Related Art

Fixed magnetic disk devices (hard disk drives) are used as storage devices for an information processing device such as a computer. A magnetic recording medium of the hard disk drive generally comprises a nonmagnetic metal underlayer, a thin film magnetic layer composed of a ferromagnetic alloy, a protective layer, and a lubricant layer sequentially formed on a nonmagnetic substrate.

With the increase in recording density in recent years, the flying height of a magnetic head has decreased and is now less than 20 nm and is still decreasing. The stability of the magnetic head's function in use is sensitive to the existence of adhered microscopic contaminant particles which may not have been removed by conventional cleaning techniques or which have may have re-adhered during conventional cleaning processes. Further reduction of the flying height of a magnetic head while at least maintaining the stability of the magnetic head's function therefore requires attention to the cleaning method employed.

One of the indicators representing the recording density of a magnetic recording medium is resolution (hereinafter referred to as Res), which is measured by a read/write test of information signals (hereinafter referred to as RAN test). The Res is defined as a ratio SH/SL, in which SH is a reproduced output signal in an R/W test at a high density recording and SL is a reproduced output signal in an R/W test at a low density recording. The recording densities in magnetic recording media are set appropriately.

By using a magnetic recording medium having a large Res, a large signal output is obtained during high density recording and the SNR (signal-to-noise ratio, a ratio of a reproduced signal to media noise) is enhanced. Consequently, high density recording requires an enhanced Res.

In order to raise the Res, it is effective to enhance degree of magnetization alignment of the magnetic recording layer in the magnetic recording medium. The degree of magnetization alignment expresses degree of variance of axes of easy magnetization of the magnetic recording layer, and is often defined by a ratio HcC/HcR (hereinafter referred to as OR—orientation ratio), wherein HcC is coercivity in the circumferential direction and HcR is coercivity in the radial direction.

A commonly used magnetic recording medium uses a nonmagnetic substrate having a Ni—P plating layer formed on a disk-shaped base plate of an aluminum alloy by an electroless plating method. The Ni—P plating layer is smoothed by a mirror surface processing and “textured” to attain good magnetic performance. Texturing is a process for forming minute irregularities along the circumferential direction on the substrate surface such as by grinding the surface with diamond powder. One of the aims in providing the minute irregular streaks is to enhance the OR value. Other ways to enhance the degree of magnetization alignment have been disclosed including improvement in the structure of a chromium underlayer and optimization of conditions in the sputtering deposition process (see Japanese Unexamined Patent Application Publication No. 2002-319116).

After the texturing process, a cleaning step is necessary to remove grinding particles of diamond and residual substances attached to the processed surface. It has been reported that the degree of magnetization alignment degrades after a cleaning treatment, such as showering with pure water or immersion in pure water, is conducted.

Such degradation may be caused by oxidation of the Ni—P plating surface. Thus, it appears that attention to suppression of any oxidation and, at the same time, attention to the cleaning method employed is required.

One proposal for suppressing oxidation employs a surfactant which easily hydrolyzes for dispersing the grinding particles used during the texturing process to protect the processed surface by adhesion thereon of an organic acid that is generated by decomposition during processing (see Japanese Unexamined Patent Application Publication No. H05-081670).

Another proposal has been disclosed in which micro bubbles or nano bubbles are supplied to a processing liquid for a substrate in an immersion processing tank to remove the particles in the processing liquid by adsorption onto the bubbles together with removal of the bubbles. The micro bubbles or nano bubbles are removed in bubble removers arranged in the route of a circulation path for the processing liquid (see Japanese Unexamined Patent Application Publication No. 2006-147617 and corresponding United States Patent Application Publication No. 2006/0054191 A1).

Although the method disclosed in Japanese Unexamined Patent Application Publication No. 2006-147617 and corresponding United States Patent Application Publication No. 2006/0054191 A1 can remove the particles that are floating in the processing liquid, the cleaning of the substrate is carried out by the known immersion method and does not suppress oxidation of the plating surface.

### SUMMARY OF THE INVENTION

It is therefore an object of the present invention to establish a method of cleaning a substrate to remove residual substances remaining on a Ni—P surface thereof and, at the same time, to suppress oxidation of the Ni—P plated surface.

To accomplish the above object, a method of cleaning a substrate for a magnetic recording medium according to the present invention cleans a surface of a substrate for a magnetic recording medium using nano-bubble water. More particularly, the present invention provides a method of cleaning a magnetic recording medium substrate having a Ni—P plating layer provided thereon, the method comprising the steps of: providing a container; placing the magnetic recording medium substrate in the container; introducing nano-bubble water comprised of pure water and nano-bubbles comprised of at least one inactive gas contained in the pure water into the container; and cleaning the magnetic recording medium substrate through contact with the nano-bubble water.

A method of manufacturing a magnetic recording medium of the invention comprises a step of cleaning a substrate defined by the method of cleaning a substrate for a magnetic recording medium as stated above and steps of sequentially forming at least a magnetic layer, a protective layer, and a liquid lubricant layer on the cleaned substrate.

The method of cleaning a substrate surface according to the invention suppresses oxidation of the substrate surface so that little or no degradation of magnetization alignment results, and removes residue substances and particles which would otherwise remain on the substrate surface.

The method of manufacturing a magnetic recording medium according to the invention comprising this method of cleaning can provide an anisotropic magnetic recording medium capable of high density recording using a nonmagnetic substrate composed of an aluminum alloy material.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following detailed description taken in connection with the accompanying drawing in which:

FIG. 1 shows a cleaning apparatus for use in an embodiment of the method of cleaning a substrate according to the invention;

FIG. 2 shows amount of oxidization measured by ESCA in the substrate after cleaning without nano-bubbles, with oxygen nano-bubbles, and with inactive gas nano-bubbles of nitrogen and helium;

FIG. 3 shows evaluation results obtained with an AFM of the degree of magnetization alignment in magnetic recording media manufactured of substrates after cleaning as in FIG. 2; and

FIG. 4 shows the number of particles remained on the surface of magnetic recording media manufactured on substrates after cleaning as in FIG. 2.

### DETAILED DESCRIPTION OF THE INVENTION

A substrate used in one embodiment of the method of cleaning a substrate surface according to the invention is a nonmagnetic substrate of an aluminum alloy material with a Ni—P plating layer on the surface and processed by texturing on the surface of the plating.

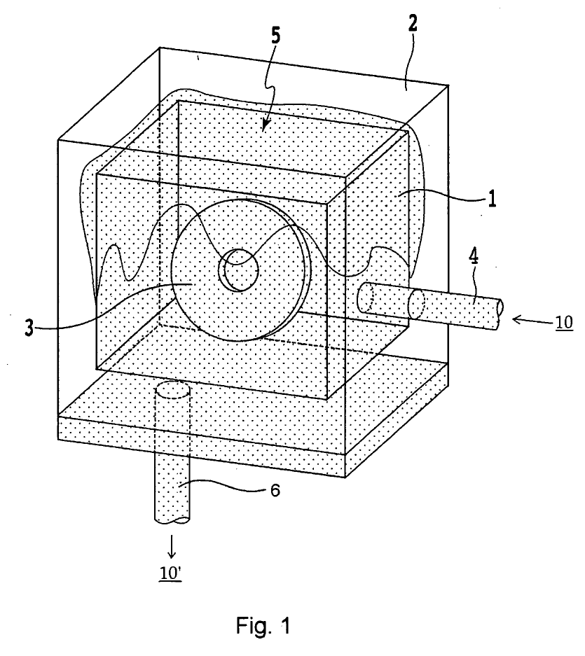

FIG. 1 shows a cleaning apparatus used in an embodiment of the method of cleaning a substrate surface according to the invention. The apparatus shown in FIG. 1 has an inner tank 1 and an outer tank 2, a substrate 3 to be cleaned being placed in the inner tank 1. Nano-bubble water 10 is introduced into the inner tank 1 through an inlet 4 provided near a bottom portion of the inner tank 1, overflowing from an opening 5 at a top portion of the inner tank, flowing in the outer tank 2 along the external walls of the inner tank, and exhausted through an outlet 6 provided at a bottom portion of the outer tank (see nano-bubble water 10′). The nano-bubble water contains minute bubbles having a diameter less than 1 μm at the moment of their generation. The bubbles are preferably composed of an inactive gas, such as nitrogen, helium or an appropriate mixture of these gases, and favorably additionally contain a reducing gas, such as carbon monoxide or hydrogen, to obtain a more stable effect. Nano-bubbles containing one or more of these gases prevent the substrate surface from oxidation during and after the cleaning process. Therefore, degradation of magnetization alignment due to oxidation can be avoided. Temperature of the nano-bubble water used in the cleaning process is preferably in the range of 10 to 50° C.

The nano-bubble water 10 introduced to the inner tank 1 flows up in the inner tank and a part of the nano-bubble water strikes against the substrate 3, cleaning the substrate 3. When a nano-bubble (not shown) comes in contact with a contaminant particle (not shown) attached to the substrate 3, the contaminant particle adheres to the nano-bubble and is removed. Contaminant particles that have moved from the substrate into the water also adhere to the nano-bubbles upon contact with the nano-bubbles, are removed by the flow, and exhausted from the tank.

In order to attain high reliability and high accuracy of a magnetic recording medium manufactured using a cleaned substrate, the substrate after the cleaning process preferably exhibits no protrusion larger than 3 nm in measurement using an AFM over a surface of 30 μm square, and preferably exhibits a center line average roughness (Ra) value in the range of 0.2 to 2.5 nm.

A method of manufacturing a magnetic recording medium according to the invention comprises a step of cleaning a substrate employing the method of cleaning the substrate as described above and steps of sequentially forming, on this substrate, at least a magnetic layer, a protective layer, and a liquid lubricant layer.

By way of example but not limitation, one embodiment (not illustrated) of a magnetic recording medium obtained by the method of manufacturing a magnetic recording medium according to the invention has a structure including a nonmagnetic underlayer, a stabilizing layer, a spacer layer, a magnetic layer, a protective layer, and a liquid lubricant layer laminated in this order on a nonmagnetic substrate that has been cleaned according to the method of cleaning a substrate as described above.

The nonmagnetic underlayer is provided for the purpose of controlling crystallinity or crystal orientation of a magnetic layer formed over the underlayer. By reducing the thickness of the underlayer to reduce the grain size of the underlayer, the grain size in the magnetic layer laminated over the substrate is also reduced. The underlayer can be a single layer or a plurality of layers. The underlayer is preferably a nonmagnetic film composed of chromium, an alloy containing a main component of chromium and at least an additive element selected from molybdenum, tungsten, titanium, vanadium, and manganese, or an appropriate mixture of these elements. A material for the underlayer has preferably a crystal lattice structure approximately similar to the crystal lattice of the magnetic layer, and the component material of the underlayer is appropriately selected to correspond to the composition of the magnetic layer. A thickness of the underlayer is preferably in the range of 4 nm to 10 nm with a view to attaining low media noise and high SNR. If the thickness of the underlayer is larger than 10 nm, the effect to reduce media noise is diminished due to swelling of magnetic particles; if the thickness of the underlayer is less than 4 nm, the media noise increases partly due to an increased variance of grain sizes of the magnetic particles. The underlayer thickness is more preferably in the range of 5 nm and 10 nm, most preferably in the range of 5 nm to 8 nm. The underlayer can be formed by a commonly used method such as a DC sputtering method or an electron beam evaporation method.

The magnetic recording medium of this exemplary embodiment has a stabilizing layer between the underlayer and the magnetic layer. The stabilizing layer is provided for generating an antiferromagnetic interaction between the magnetic layer and the stabilizing layer. The stabilizing layer is preferably formed in a pair with a spacer layer formed on the stabilizing layer. The strength of the antiferromagnetic interaction varies depending on compositions and thicknesses of the stabilizing layer, the spacer layer and the magnetic layer, conditions (pressure, atmospheric gas and the like) in the process of depositing these layers, and other factors such as smoothness of the layers. One pair of stabilizing layer and spacer layer can be provided, or an additional pair(s) of stabilizing layer and spacer layer can be formed, as long as the antiferromagnetic interaction is generated with the magnetic layer.

The stabilizing layer is preferably a magnetic film composed of an alloy containing a main component of cobalt and at least one additive element selected from chromium, tantalum, platinum, boron, and copper, or an appropriate mixture containing these elements. Specific examples of this alloy include CoCr, CoTa, CoCrTa, CoCrPt, and CoCrPtTa. Since the strength of the antiferromagnetic interaction varies depending on the thickness and composition of the stabilizing layer as described previously, the thickness and composition of the stabilizing layer are selected to attain a stronger antiferromagnetic interaction. In order to attain a strong antiferromagnetic interaction, the thickness of the stabilizing layer is preferably in the range of 2 nm to 15 nm, more preferably in the range of 4 nm to 12 nm. It is preferable that the remanent magnetization of the stabilizing layer is less than that of the magnetic layer and the coercivity of the stabilizing layer is less than that of the magnetic layer. This is because the magnetization of the magnetic layer needs to be more stable than the magnetization of the stabilizing layer, since the orientation of the latter changes with the orientation of the former. Values of remanent magnetization of the stabilizing layer and the magnetic layer vary depending on the composition and thickness of those layers and conditions in the process of depositing those layers. In a magnetic recording medium of the invention, no restriction is posed on the range of values of remanent magnetization of those layers. The stabilizing layer can be formed by a commonly employed method such as a DC sputtering method or an electron bean evaporation method.

The spacer layer is preferably a nonmagnetic film composed of an element selected from ruthenium, rhenium and osmium, or an alloy comprising at least one of these elements, or an appropriate mixture of these elements. Since the strength of antiferromagnetic interaction varies depending on the thickness and composition of the spacer layer as mentioned previously, the thickness and composition of the spacer layer can be selected to give a strong antiferromagnetic interaction. In order to attain a strong antiferromagnetic interaction, the thickness of the spacer layer is preferably in the range of 0.5 nm to 1.2 nm, more preferably in the range of 0.7 nm to 0.9 nm. The crystal lattice structure of the spacer layer is preferably a hexagonal structure. This is for the purpose of promoting continuous crystal growth between the spacer layer and the stabilizing layer and between the spacer layer and the magnetic layer, both the stabilizing layer and the magnetic layer being composed of an alloy of a main component of cobalt and having the hexagonal lattice structure. The continuous crystal growth reduces the media noise. The spacer layer can be formed by a commonly used method such as a DC sputtering method or an electron beam evaporation method.

The magnetic layer is a magnetic recording layer for recording and reproducing information. The magnetic layer is preferably a magnetic film composed of an alloy of a main component of cobalt and at least an additional element selected from chromium, tantalum, platinum, boron, and copper, or an appropriate mixture containing these elements. Specific examples of the alloy include CoCr, CoCrTa, CoCrPt, and CoCrPtTa. In addition, as described previously, it is preferable that the remanent magnetization of the stabilizing layer is less than that of the magnetic layer and the coercivity of the stabilizing layer is less than that of the magnetic layer. Since the strength of the antiferromagnetic interaction varies with the thickness and composition of the magnetic layer as described previously, the thickness and composition of the magnetic layer are selected so as to attain a strong antiferromagnetic interaction. The magnetic layer can be formed by a commonly employed method such as a DC sputtering method or an electron beam evaporation method.

A protective layer is preferably provided on the magnetic layer in a magnetic recording medium of the invention. The protective layer is provided for the purpose of protecting the magnetic layer from head collision and corrosion due to external corrosive substances. The protective layer can be formed from any substances that provide these functions and is not restricted to any special material. Nevertheless, preferred specific materials include carbon, nitrogen-containing carbon, and hydrogen-containing carbon. The thickness of the protective layer is typically less than 10 nm. Both single and multiple layers are possible. The protective layer can be formed by a sputtering method, a CVD method, or an FCA (Filtered Cathodic Arc) method.

A liquid lubricant layer is preferably provided on the protective layer. The liquid lubricant layer is provided for the purpose of avoiding crashes with the head in use. Useful materials for the liquid lubricant layer are, for example, an organic substance represented by the formula: HO—CH₂—CF₂—(CF₂—O)ₘ—(C₂F₄—O)ₙ—CF₂—CH₂—OH (where n+m is about 40). A thickness of the liquid lubricant layer is set at a value that provides the liquid lubricating function taking the film quality of the protective layer into consideration. The liquid lubricant layer can be formed by any commonly employed application method.

Any other layers can be provided by any appropriate method according to the conditions of specific application of the recording medium. For example, a nonmagnetic metal seed layer can be provided under the underlayer for the purpose of alignment control in the magnetic layer, and minimization of grains or reduction of variance of grain sizes in the magnetic layer. Further, for the purpose of crystallographic matching of the magnetic layer, a magnetic metallic intermediate layer can be formed between the underlayer and the magnetic layer as long as it does not adversely affect the functions of the spacer layer and the stabilizing layer described previously.

### EXAMPLES

The present invention will be described further in detail with reference to some specific examples.

### Example 1

A substrate with a Ni—P plating on the surface thereof was used and grooves were formed on the Ni—P plating film by texturing. Then, in a cleaning step, the substrate was immersed in nano-bubble water to clean the substrate using the apparatus shown in FIG. 1. The nano-bubble water contained nano-bubbles of nitrogen generated in pure water. The nano-bubbles were generated using a commercially available nano-bubble generator apparatus (Type AS-K1 manufactured by Asupu Co., Ltd.)

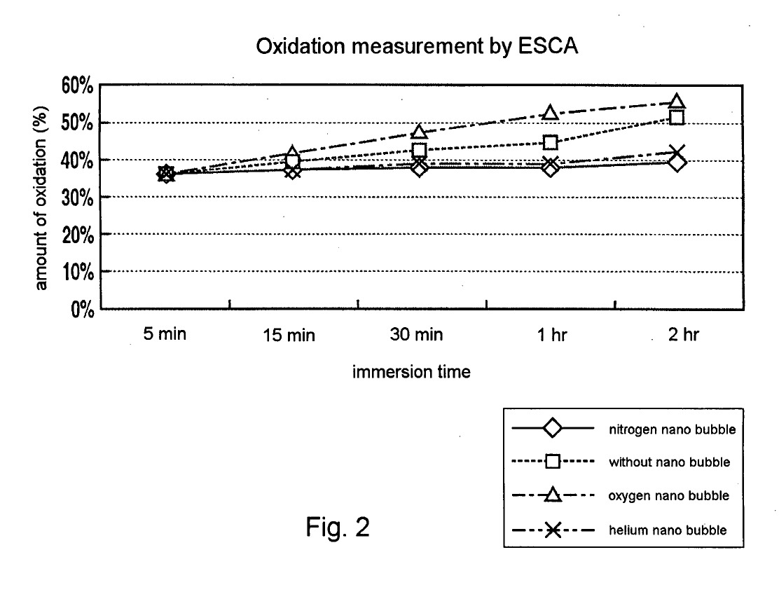

FIG. 2 shows amount of oxidation (as a percent) on the surface of the substrate cleaned in this method using nitrogen nano-bubbles measured by ESCA (electron spectroscopy for chemical analysis). Table 1 gives numerical data of percent of oxygen versus immersion time.

After cleaning with nano-bubble water containing nano-bubbles of nitrogen, the substrate was heated, and sequentially laminated on the substrate using a DC sputtering apparatus were an underlayer of a chromium alloy, a stabilizing layer of CoTa, a magnetic layer of CoCrPt, and a carbon protective layer. A liquid lubricant was applied on the carbon protective layer to complete a magnetic recording medium. Magnetization alignment (OR: orientation ratio) was evaluated on the magnetic recording medium.

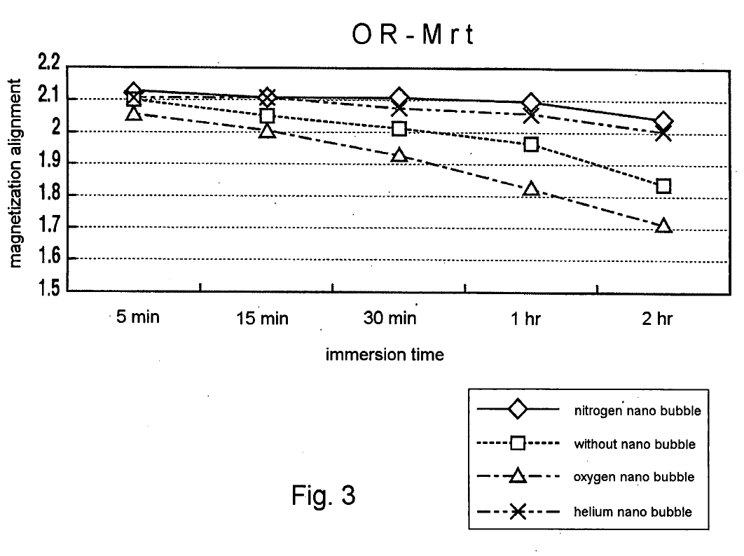

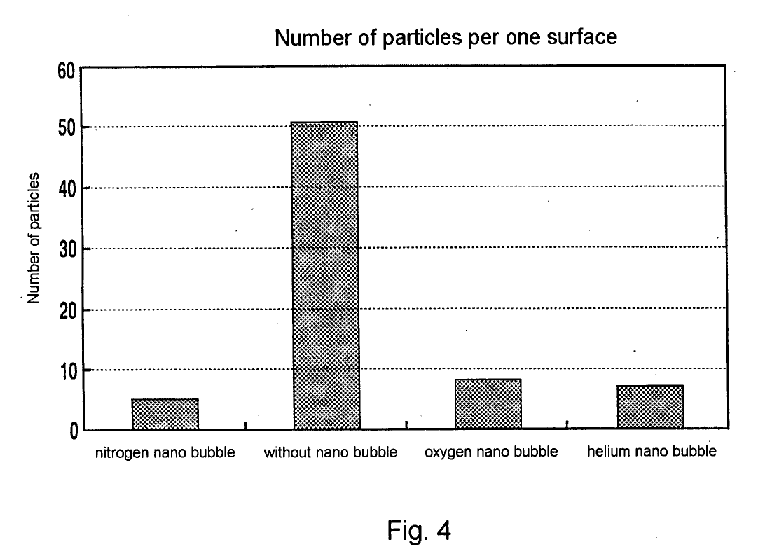

FIG. 3 is a graph showing the orientation ratio measured on the magnetic recording medium, and Table 2 gives numerical values of the OR. Number of particles remaining on the substrate surface was measured on the magnetic recording medium. FIG. 4 shows the number of particles measured by an optical surface analyzer model OSA-6100 manufactured by Candela Instruments Inc. and Table 3 gives the numerical data.

### Example 2

A cleaning process was conducted similarly to Example 1 except that nano-bubble water was prepared generating nano-bubbles of helium in place of nano-bubbles of nitrogen. Using the thus cleaned substrate, measurements were made on the amount of oxygen on the substrate surface, the OR values of the magnetic recording medium, and the number of particles remaining on the substrate surface of the magnetic recording medium in the same way as in Example 1. The results are shown in Tables 1 through 3 and FIGS. 2 through 4.

### Comparative Example 1

A cleaning process was conducted similarly to Example 1 except that the nitrogen nano-bubble water was replaced by pure water. The amount of oxygen on the substrate surface was measured, the result of which is given in FIG. 2 and Table 1 together with the results on Example 1.

A magnetic recording medium was fabricated similarly to Example 1 except that the thus-cleaned substrate was used. The magnetization alignment (OR) was measured on the magnetic recording medium, the results of which are given in FIG. 3 and Table 2 together with the results on Example 1.

The number of particles remaining on the substrate surface of the thus-fabricated magnetic recording medium was determined and the results are shown in FIG. 4 and Table 3 together with the result on Example 1.

### Comparative Example 2

A cleaning process was conducted similarly to Example 1 except that the nitrogen nano-bubble water was replaced by oxygen nano-bubble water. Using the thus-cleaned substrate, measurements were made on the amount of oxygen on the substrate surface, the OR values of magnetic recording medium, and the number of particles remaining on the substrate surface of the magnetic recording medium in the same way as in Example 1. The results are shown in Tables 1 through 3 and FIGS. 2 through 4 together with the results on Example 1.

TABLE 1
Amount of oxygen (as a percent) on substrate surface

| | | | 15 | 30 | | |
|---|---|---|---|---|---|---|
| | After | 5 min | min | min | 1 hr | 2 hr |
| Example 1 | Nitrogen nano-bubbles | 36% | 37% | 38% | 38% | 39% |
| Comp Ex 1 | Without nano-bubbles | 36% | 39% | 42% | 44% | 51% |
| Comp Ex 2 | Oxygen nano-bubbles | 36% | 41% | 47% | 52% | 55% |
| Example 2 | Helium nano-bubbles | 36% | 37% | 39% | 39% | 41% |

TABLE 2
Orientation Ratio

| | | | 15 | 30 | | |
|---|---|---|---|---|---|---|
| | After | 5 min | min | min | 1 hr | 2 hr |
| Example 1 | Nitrogen nano-bubbles | 2.12 | 2.10 | 2.10 | 2.09 | 2.03 |
| Comp Ex 1 | Without nano-bubbles | 2.10 | 2.05 | 2.01 | 1.96 | 1.83 |
| Comp Ex 2 | Oxygen nano-bubbles | 2.06 | 2.01 | 1.93 | 1.82 | 1.71 |
| Example 2 | Helium nano-bubbles | 2.10 | 2.10 | 2.07 | 2.05 | 2.00 |

TABLE 3
Number of particles remaining per one surface

| | | Particles/surface |
|---|---|---|
| Example 1 | Nitrogen nano-bubbles | 5.3 |
| Comp Ex 1 | Without nano-bubbles | 50.5 |
| Comp Ex 2 | Oxygen nano-bubbles | 8.2 |
| Example 2 | Helium nano-bubbles | 7.1 |

As shown clearly in Table 1, the results on Examples 1 and 2 are superior to the results on Comparative Examples 1 and 2. Thus, these results demonstrate that the cleaning according to the method of cleaning a substrate of the invention suppresses oxidation of the Ni—P plated surface on the aluminum alloy substrate.

The results in Table 2 also show that the results on Examples 1 and 2 are superior to the results on Comparative Examples 1 and 2. Thus, these results demonstrate that the cleaning according to the method of cleaning a substrate of the invention causes little or no degrading of the magnetization alignment of the magnetic recording medium.

The results in Table 2 also show clearly that the results on Examples 1 and 2 are superior to the results on Comparative Examples 1 and 2. These results demonstrate that the cleaning according to the method of cleaning a substrate of the invention reduces the number of particles remaining on the Ni—P plating surface of the aluminum alloy substrate, thus, exhibiting a significant cleaning effect.

The method of cleaning a substrate surface according to the invention removes residue substances and particles on a substrate surface. By cleaning, with nano-bubble water containing gas bubbles, a substrate that has Ni—P plating film formed on the surface of a nonmagnetic substrate of an aluminum alloy and subjected to texturing process, oxidation of the substrate surface is suppressed and magnetization alignment is hardly degraded.

A method of manufacturing a magnetic recording medium according to the invention employs this method of cleaning and provides an anisotropic magnetic recording medium capable of high density recording using a nonmagnetic substrate composed of an aluminum alloy.

It is understood that various other modifications will be apparent to and can be readily made by those skilled in the art without departing from the scope and spirit of the present invention. Accordingly, it is not intended that the scope of the claims appended hereto be limited to the description set forth above but rather that the claims be construed as encompassing all of the features of patentable novelty which reside in the present invention, including all features which would be treated as equivalents thereof by those skilled in the art to which the invention pertains.

What is claimed is:

1. A method of cleaning a substrate for a magnetic recording medium, comprising the steps of:
placing a magnetic recording medium substrate in a container; and
cleaning the surfaces of the magnetic recording medium substrate using nano-bubble water.

2. The method of cleaning a substrate for a magnetic recording medium according to claim 1, wherein the nano-bubble water comprises pure water and nano-bubbles of at least one inactive gas contained in the pure water.

3. The method of cleaning a substrate for a magnetic recording medium according to claim 2, wherein the nano-bubbles further comprise a reducing gas.

4. The method of cleaning a substrate for a magnetic recording medium according to claim 1, wherein the nano-bubble water comprises pure water and minute bubbles having a diameter of less than 1 μm contained in the pure water.

5. The method of cleaning a substrate for a magnetic recording medium according to claim 1, further comprising, prior to the step of placing the magnetic recording medium substrate in the container, texturing the magnetic recording medium substrate.

6. The method of cleaning a substrate for a magnetic recording medium according to claim 1, further comprising, prior to the step of placing the magnetic recording medium substrate in the container,
providing a Ni—P plating layer on the magnetic recording medium substrate; and
texturing the Ni—P plating layer on the magnetic recording medium substrate.

7. A method of manufacturing a magnetic recording medium, comprising the steps of:
cleaning a magnetic recording medium substrate by the method according to claim 1 to provide a cleaned substrate;
forming at least a magnetic layer on the cleaned substrate;
forming a protective layer on the at least a magnetic layer; and
providing a liquid lubricant layer on the protective layer.

8. A method of cleaning a magnetic recording medium substrate having a Ni—P plating layer provided thereon, the method comprising the steps of:
providing a container;
placing the magnetic recording medium substrate in the container;
introducing nano-bubble water comprised of pure water and nano-bubbles comprised of at least one inactive gas contained in the pure water into the container; and
cleaning the magnetic recording medium substrate through contact with the nano-bubble water so that particulates are removed and oxidation of the Ni—P plating layer is suppressed.

9. The method according to claim 8, wherein the at least one inactive gas is comprised of nitrogen, helium, and mixtures thereof.

10. The method according to claim 8, wherein the nano-bubbles further comprise a reducing gas so that oxidation of the Ni—P plating layer during and after cleaning is additionally reduced and so that degradation of magnetization alignment of the magnetic recording medium due to oxidation of the Ni—P plating layer is reduced.

11. The method according to claim 10, wherein the reducing gas is comprised of carbon monoxide, hydrogen, and mixtures thereof.

12. The method according to claim 8, wherein the nano-bubbles have a diameter when generated of less than 1 μm.

13. The method according to claim 8, further comprising, prior to placing the magnetic recording medium substrate in the container, texturing the Ni—P plating layer of the magnetic recording medium substrate.

14. The method according to claim 13, wherein the magnetic recording medium substrate after texturizing has a center line average roughness (Ra) value which ranges from 0.2 to 2.5 nm.

15. The method according to claim 8, wherein the nano-bubble water has a temperature ranging from 10 to 50° C.

16. The method according to claim 8, wherein the container comprises (a) an inner tank having top and bottom portions, having an inlet provided near the bottom portion through which the nano-bubble water is introduced into the inner tank, and having an opening provided at the top portion of the inner tank from which the nano-bubble water overflows, and (b) an outer tank surrounding the inner tank and receiving the overflow of nano-bubble water from the opening of the inner tank as the nano-bubble water flows along external walls of the inner tank, the outer tank having top and bottom portions, and having an outlet provided near the bottom portion of the inner tank through which the nano-bubble water is exhausted.

17. The method according to claim 8, wherein cleaning is accomplished when the nano-bubble water strikes against the magnetic recording medium substrate and any particulates present on the surface of the magnetic recording medium and in the nano-bubble water adhere to the nano-bubbles and are removed.

18. The method according to claim 8, wherein cleaning the magnetic recording medium substrate through contact with the nano-bubble water is continued until the magnetic recording medium substrate has no protrusion larger than 3 nm over a surface of 30 μm square using an AFM, and a center line average roughness (Ra) value which ranges from 0.2 to 2.5 nm.

19. A method of manufacturing a magnetic recording medium, comprising the steps of:
cleaning a magnetic recording medium substrate by the method according to claim 8 to provide a cleaned substrate;
forming at least a magnetic layer on the cleaned substrate;
forming a protective layer on the at least a magnetic layer; and
providing a liquid lubricant layer on the protective layer.

20. The method of manufacturing a magnetic recording medium according to claim 19, wherein cleaning the magnetic recording medium substrate through contact with the nano-bubble water is continued until the magnetic recording medium substrate has no protrusion larger than 3 nm over a surface of 30 μm square using an AFM, and a center line average roughness (Ra) value which ranges from 0.2 to 2.5 nm so that high reliability of the manufactured magnetic recording medium is obtained.
